(19) United States
(12) Patent Application Publication
(10) Pub. No.: US 2008/0068154 A1
(43) Pub. Date: Mar. 20, 2008

(54) Method for Assisting the Orientation of a Mobile Terminal User

(75) Inventor: Veronique Daurensan, Antony (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/575,205

(22) PCT Filed: Sep. 14, 2005
(86) PCT No.: PCT/FR05/50742

§ 371 Date: Oct. 18, 2007

(30) Foreign Application Priority Data
Sep. 14, 2004 (FR) 0452045

(51) Int. Cl. H04Q 7/00

(52) U.S. Cl. 340/539.13

(57) ABSTRACT

The invention relates to methods for assisting the orientation of a mobile terminal user. Said method, for assisting the orientation of a mobile terminal user, displays, on the screen of the mobile terminal, a map (1) of a locality, the position (2, 4) of the mobile terminal on the map, at least a part of the route to follow (11 to 14) to get from the position (2) of the mobile terminal to a destination (3) given or approved by the user of the mobile terminal, at least a part, close to the position (4) of the mobile, of the path actually followed (21) over time by the mobile terminal, display of the position (4) of the mobile terminal mobile and display of the path actually followed (21) being automatically updated over time.

The invention concerns the field of methods for assisting the orientation of a mobile terminal user, and mobile terminals intended to implement these methods for assisting the orientation of a mobile terminal user and the servers intended to implement these methods for assisting the orientation of a mobile terminal user. One of the preferred applications is that which assists a mobile terminal user who is lost to find his way again, in particular if that user is lost in an area having few landmarks, for example lost in the middle of the trees of a forest, in a landscape uniformly covered with snow, etc.

According to prior art described in the American patent application US 2002/0173906, for example, it is known to display the position of the user of the mobile terminal and the direction that he must follow. A drawback of this prior art is that a simple direction is insufficient information, especially if the locality in which the user finds himself includes few landmarks: the insufficiency of this information will be more apparent in the middle of the trees of a close-packed forest than in the streets of a town.

The invention proposes a method for assisting the orientation of a mobile terminal user which assists a lost user to find his way again simply and quickly, even if, on the one hand, the user is lost in a place having relatively few landmarks and even if, on the other hand, the user has also lost some of his capacity for lucid thought because of irritation or distress.

According to the invention, there is provided a method for assisting the orientation of a mobile terminal user, displaying, on the screen of the mobile terminal, a map of a locality; the position of the mobile terminal on the map; at least a part of the path to follow to get from the position of the mobile terminal to a destination designated or validated by the user of the mobile terminal; at least a part, close to the position of the mobile terminal, of the path actually followed over time by the mobile terminal; the display of the position of the mobile terminal and display of the part of the path actually followed being automatically updated over time.

The invention will be better understood and other features and advantages will become apparent with the aid of the following description and the appended drawings, given by way of example, in which:

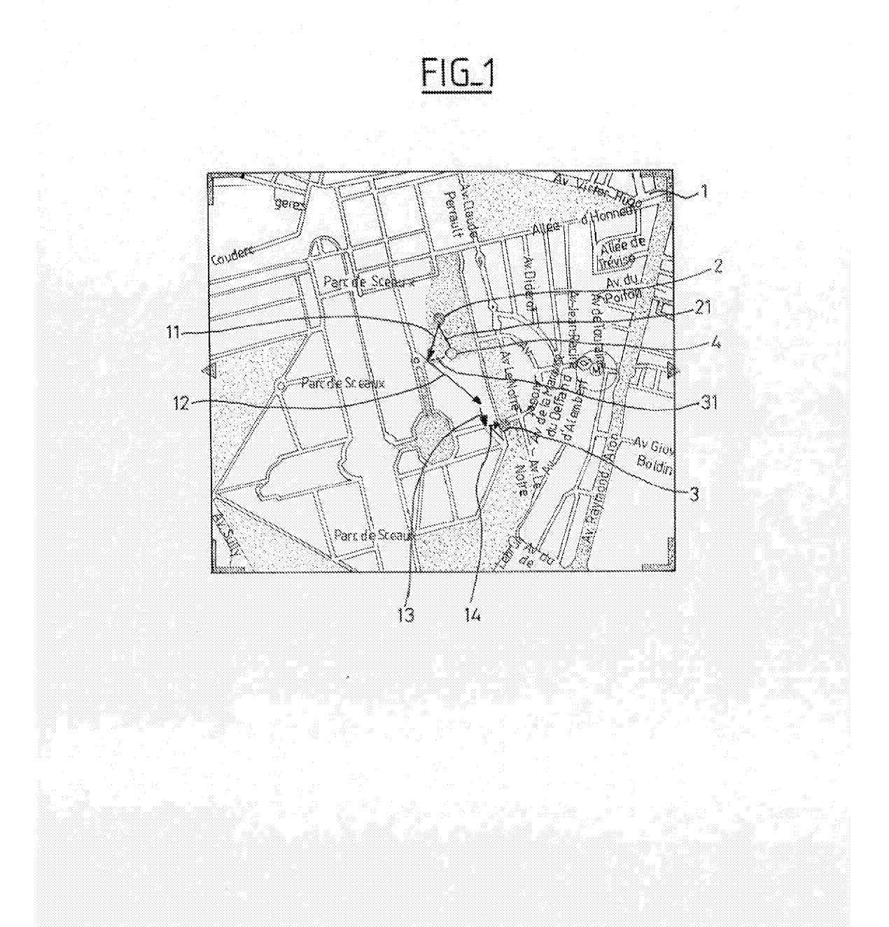

FIG. 1 represents diagrammatically an example of a map of a locality displayed on the screen of a mobile terminal of a user, highlighting the position of the mobile terminal, the destination of the user, the path to be followed, and the path followed, conforming to a preferred embodiment of the orientation assistance method according to the invention.

FIG. 1 represents diagrammatically an example of a map of a place displaced on the screen of a mobile terminal of a user, highlighting the position of the mobile terminal, the destination of the user, the path to be followed, and the path followed, conforming to a preferred embodiment of the orientation assistance method according to the invention. A map 1 of a locality comprising streets, footpaths, areas with dwellings and forest areas is displayed on the screen of the mobile terminal of the user. The mobile terminal is preferably a mobile telephone. The position 2 represents a past position of the user who was lost in the middle of the trees of a forest area and who submitted a request to find his way again to the server via his mobile terminal in order to make his way to a particular exit from the park, which is the destination 3. The destination 3 may be either chosen by the user, for example if the user requests a particular exit from the park by clicking on the map 1 displayed on the screen of his mobile terminal, or validated by the user, for example if the user requests the exit from the park closest to his position and accepts by clicking it that proposed to him on the display on the screen of his mobile terminal. From this position 2, the path to follow is indicated, for example in segments. Here the path to follow to go from the position 2 to the destination 3 consists of four segments 11 to 14. First of all the segment 11 that consists in crossing a forest area with no landmarks in a given direction to get to a footpath, then the segment 12 that follows a path, then the segment 13 that follows another footpath, and finally the segment 14 that follows yet another footpath leading to the destination 3. At the outset, when the user is at his initial position 2, for example only the segments 11 and 12 may be displayed. Then when the user is walking along the footpath corresponding to the segment 12, for example only the segments 12 and 13 are displayed. More generally, for example only the current segment and the next segment may be displayed. The destination 3 may be displayed or not especially if it is sufficiently far from the initial position 2 that it cannot be displayed on the same map 1 as the initial position 2. Once the user has begun to move, his new position, the current position 4 is also displayed. The user has not followed the recommended segment 11, but has actually followed the segment 21 slightly further to the south to reach a footpath other than that indicated by the path to follow. The user may realize that by now following the segment 31 he can return simply and quickly to the recommended segment 12. That segment 31 may also be displayed to him in a different way. While his current position is automatically updated, for example periodically with a relatively short period so that the user can easily correct his route, for example from the initial position 2 to the current position 4, the path to follow is preferably updated only at the express request of the user. The user attempts to follow the segment 11 as best he can, but actually follows the segment 21 to arrive at the position 4. An update to the path to follow, obtained by the user simply clicking, for example, can then delete the segment 11 and display instead of it the segment 31. The whole of the path to follow and of the path actually followed are preferably displayed on the screen of the terminal, provided that they do not overshoot the map 1. There may be provision, by way of an advantageous option, if the user is going round in circles and crosses a path he has previously taken, for a forced updating of the path to follow to be effected so that the screen remains legible for the user and to prevent the path actually followed resembling a tangled ball of wool. The simultaneous display of at least a portion of the path to follow and at least a portion of the path followed in the vicinity of the current position of the user enables the user simply and effectively to visualize the corrections to be made to his movement in order to return to the path to follow as soon as possible. This simultaneous display, which allows direct and differentiated visualization of the path to follow and the path actually followed, enables a user, even if lost in a place with no landmarks and/or in a slight panic, to find his way again quickly, whereas the simple indication of a position and of a direction to follow, necessitating a few landmarks and/or a few elementary reasoning operations to find his way again, may in such cases be insufficient or at least less effective and less safe for the user and/or take the user longer. Moreover, if the server wishes to have the user make a detour to reach the destination, for example because the path is more practical along the detour, with the display of the whole of the path to follow or at least a significant portion of the path to follow, this is immediately clear to the user, whereas the display of a simple direction that changes over time may give him the impression of going round in circles or of having no idea where he is going. Comparison of the length of the path actually followed and the remaining or total length of the path to follow can also give him an idea of the time it will take him to reach the intended destination.

In a preferred embodiment, each updating of the display of the portion of the path to follow results from an express request from the user of the mobile terminal. In fact, excessively frequent automatic updating would not enable the user to realize the relevance of the path actually followed compared to the path to follow; he would run the risk of following a tortuous path ceaselessly oscillating around the perpetually updated path to be followed.

In another embodiment, the display of the portion of the path to follow is updated automatically over time, but less often than the display of the portion of the path actually followed. The period for updating the path to follow is in this case advantageously much longer than the period for updating the path actually followed. This long period should preferably correspond to a significant movement along the path actually followed displayed on the screen of the terminal. At least a few millimeters, typically at least 3 or at least 5 or at least 10 millimeters, must in this advantageous case have been traveled on the screen of the mobile terminal by the user.

The displayed portion of the path to follow and the displayed portion of the path actually followed are displayed differently on the user's screen, so that the user cannot confuse them, preferably even briefly, which could otherwise cause him to panic. The displayed portion of the path to follow and the displayed portion of the path actually followed are preferably displayed by means of different colors, for example the path to follow may be displayed in green whereas the path actually followed may be displayed in red. The displayed portion of the path to follow and the displayed portion of the path actually followed may equally be displayed by other means, for example solid line for the path to follow and dashed line for the path actually followed, or steady line for the path to follow and blinking line for the path actually followed.

The map is preferably downloaded from a server to the mobile terminal via a mobile telecommunication network. Accordingly, in contrast to the GPS, the user does not need to have the map of the place where he is located stored in his mobile terminal, which is good because it is difficult for the user to predict in advance where he is going to get lost, the other alternative for the user being to store all the maps of all the places that he is likely to go, which quickly becomes costly and tiresome. Thus his mobile telephone, for example, can fulfill this function without the user having to burden himself with a GPS device in addition to his mobile telephone. The updates are preferably supplied to the mobile terminal by a server via a mobile telecommunication network. In one advantageous embodiment, the mobile telecommunication network is the GPRS. In another advantageous embodiment, the mobile telecommunication network is the UMTS. The chosen network preferably allows accurate location, to avoid the user going the wrong way. If the accuracy is insufficient, the user may take the wrong street in a town or the wrong path in a forest, which is irritating.

1. Method for assisting the orientation of a mobile terminal user, displaying, on the screen of the mobile terminal:
a map (1) of a locality;
the position (2, 4) of the mobile terminal on the map;
at least a part of the path (11 to 14) to follow to get from the position (2) of the mobile terminal to a destination (3) designated or validated by the user of the mobile terminal;
at least a part (21), close to the position (4) of the mobile terminal, of the path actually followed over time by the mobile terminal;
the display of the position (4) of the mobile terminal and the display of the part (21) of the path actually followed being automatically updated over time.

2. Method according to claim 1, characterized in that each update of the display of the part of the path to follow results from an express request from the user of the mobile terminal.

3. Method according to claim 1, characterized in that the display of the part of the path to follow is updated automatically over time but less often than the display of the part of the path actually followed.

4. Method according to claim 1, characterized in that the displayed part of the path to follow and the displayed part of the path actually followed are displayed in different colors.

5. Method according to claim 1, characterized in that the map is downloaded from a server to the mobile terminal via a mobile telecommunication network.

6. Method according to claim 1, characterized in that the updates are supplied to the mobile terminal by a server via a mobile telecommunication network.

7. Method according to claim 5, characterized in that the mobile telecommunication network is the GPRS.

8. Method according to claim 5, characterized in that the mobile telecommunication network is the UMTS.

9. Method according to claim 1, characterized in that the destination is also displayed on the screen of the mobile terminal.

10. Mobile terminal according to claim 1 adapted to implement the method for assisting the orientation of a mobile terminal user.

11. Server according to claim 1 adapted to implement the method for assisting the orientation of a mobile terminal user.
